(19) United States
(12) Patent Application Publication
(10) Pub. No.: US 2025/0139264 A1
(43) Pub. Date: May 1, 2025

(54) SYSTEM AND METHOD FOR TRACEABLE SOFTWARE DEVELOPMENT AND DEPLOYMENT

(71) Applicant: ARRIS Enterprises LLC, Horsham, PA (US)

(72) Inventors: James Jian NI, Medford, MA (US); Xin QIU, San Diego, CA (US); Ting YAO, San Diego, CA (US)

(73) Assignee: ARRIS Enterprises LLC, Horsham, PA (US)

(21) Appl. No.: 18/806,521

(22) Filed: Aug. 15, 2024

Related U.S. Application Data
(60) Provisional application No. 63/546,480, filed on Oct. 30, 2023.

(51) Int. Cl. G06F 21/62; G06F 8/70; G06F 21/60

(52) U.S. Cl. CPC G06F 21/6209; G06F 8/70; G06F 21/602

(57) ABSTRACT

A method and apparatus for traceably managing software throughout its life cycle is disclosed. In one embodiment, the method comprises accepting, in secure management service via a first client interface module of a set of client interface modules, a request from a member of a plurality of members of the software supply chain to sign designated information, the designated information associated with the secure software in at least one of the plurality of stages, signing the designated information in response to the request according to a private key of a key pair uniquely associated with the member, and providing the signed designated information to the member of the software supply chain.

### CROSS-REFERENCE TO RELATED APPLICATIONS

This application claims benefit of U.S. Provisional Patent Application No. 63/546,480, entitled “ATTESTABLE SECURE SOFTWARE SUPPLY CHAIN SOLUTION,” by James Jian Jian Ni, Xin Qiu, and Ting Yao, filed Oct. 30, 2023, which application is hereby incorporated by reference herein.

### BACKGROUND

### 1. Field

The present disclosure relates to systems and methods for traceably managing the development, deployment, and execution of software throughout its life cycle.

### 2. Description of the Related Art

Software security encompasses a broad array of practices, tools, and methodologies aimed at protecting software systems from malicious attacks, unauthorized access, and vulnerabilities that could compromise data integrity, user privacy, and system functionality. As cyber threats continue to evolve in sophistication and frequency, the importance of robust software security measures increases.

### SUMMARY

To address the requirements described above, this document discloses a system and method for traceably planning, designing, developing, deploying, and operating software. In one embodiment, the method comprises accepting, in secure management service via a first client interface module of a set of client interface modules, a request from a member of a plurality of members of the software supply chain to sign designated information, the designated information associated with the secure software in at least one of the plurality of stages, signing the designated information in response to the request according to a private key of a key pair uniquely associated with the member, and providing the signed designated information to the member of the software supply chain. Another embodiment is evidenced by an apparatus having a processor and a communicatively coupled memory storing processor instructions for performing the foregoing operations.

The features, functions, and advantages that have been discussed can be achieved independently in various embodiments of the present invention or may be combined in yet other embodiments, further details of which can be seen with reference to the following description and drawings.

### BRIEF DESCRIPTION OF THE DRAWINGS

Referring now to the drawings in which like reference numbers represent corresponding parts throughout:

FIGS. 1A and 1B are diagrams presenting illustrations of an overview of software supply chain security related elements by stage of software development;

FIGS. 2A and 2B are diagrams presenting illustrations of exemplary software dossier contributions for each stage;

FIGS. 3A and 3B are diagrams illustrating an overview of the software management system;

FIG. 4 is a diagram presenting summary of different levels of software trustworthiness;

FIGS. 5A and 5B is a diagram illustrating the dissemination of software with Level 1 trustworthiness and Level 2 trustworthiness, respectively;

FIGS. 6A-6E are a diagrams illustrating exemplary operations of the software management system;

FIG. 7 is a diagram presenting another diagram illustrating exemplary operations of the software management system;

FIG. 8 is a diagram presenting a diagram illustrating further exemplary operations of the software management system; and

FIG. 9 is a diagram illustrating an exemplary computer system that could be used to implement processing elements software management system.

### DESCRIPTION

In the following description, reference is made to the accompanying drawings which form a part hereof, and which is shown, by way of illustration, several embodiments. It is understood that other embodiments may be utilized and structural changes may be made without departing from the scope of the present disclosure.

### Overview

The development and deployment of software involved a number of stages, including planning and analysis, design, development, build, integration testing, quality assurance, releasing, orchestration and deployment, operation and maintenance, and support termination. At each of these stages, issues may arise that affect the security or operability of the software. For example, code may have been secretly incorporated into the code by a rogue employee that could be used to compromise the code's security after deployment. Accordingly, security scanning, protection and declaration are required in the entire life cycle throughout all stages. Further, security requirements from regulatory organizations and users are no longer limited to self-declaration of security conformance, but extended to include signing, verification, and the collection and securing of evidence that such security requirements have been complied with.

Described below is a system and method for providing an attestable secure software supply chain security solution that provides highly secured software signing, verification and attestation mechanisms and software security evidence signing, verification and attestation mechanisms. With the proposed solution, software vendors and users will have options to make use of the mechanisms to specify software production security protection preference throughout all production stages by vendors, and specify software product acceptance, deployment, operation, and maintenance etc. required security verification and attestation on both software and evidences by users.

In the system described below, the entity requesting the signature does not hold the private key used for generating signatures. Instead, the signing keys are held by a communicatively coupled software management system in a secure keystore, and information designated by the entity for signature is signed by the software management system, and the signature is returned to the entity, along with the public key or certificate containing the public key (if a one-time signing key is used). An optional signing artifact may be included. This allows the entity to check and ensure that relevant information about the signing matches what the entity desires.

Verification and attestation can be performed by other entities in the software supply chain or by a software repository server, and signatures can be verified locally or remotely (in cases where the users do not have the public key). Attestation can be accomplished by additional validation using a signing artifact securely maintained in the signing service database of the software management system. The signing artifact can also be signed as an attestation service of the software management system. Further, so that private key misuse can be identified, entities are informed each time their private key is used (so that misuse can be identified) by the software management system and/or the software owners.

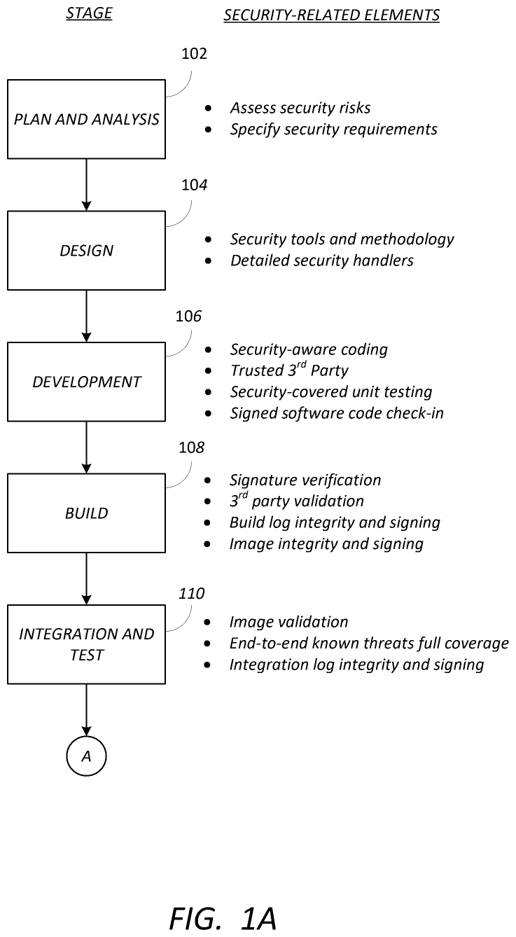

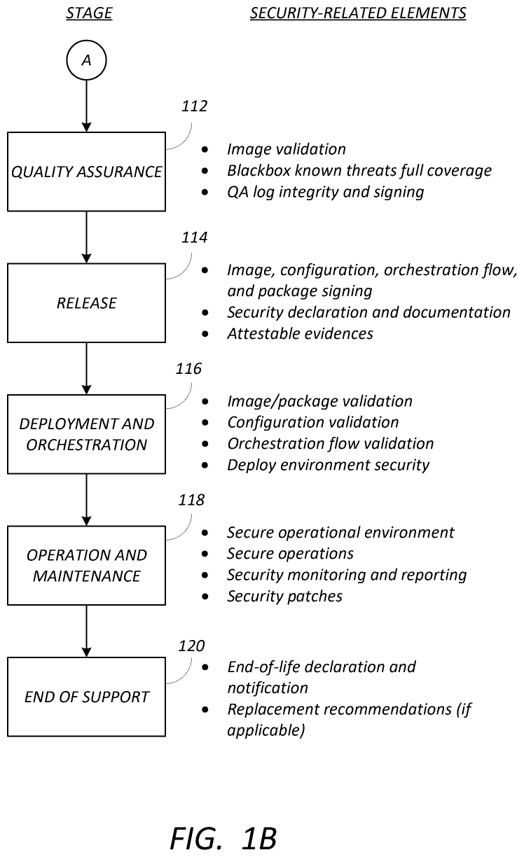

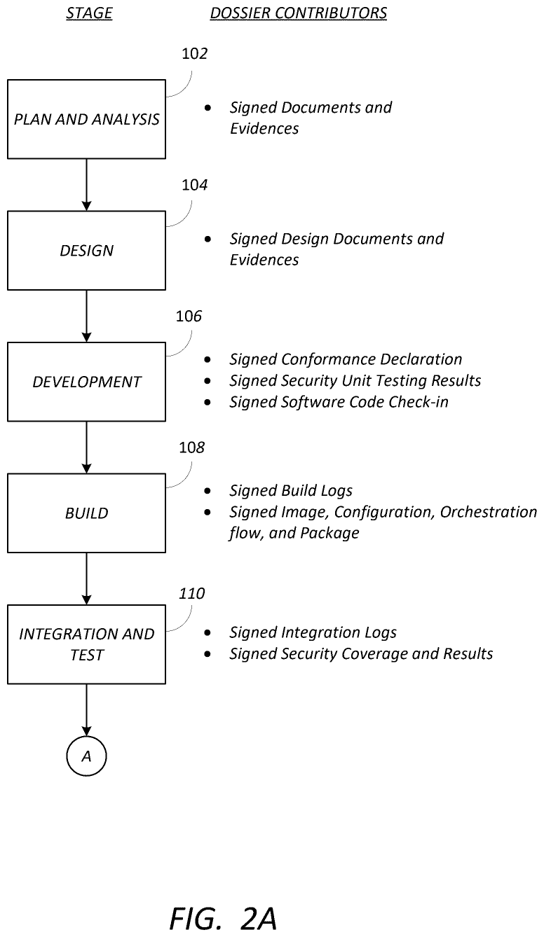

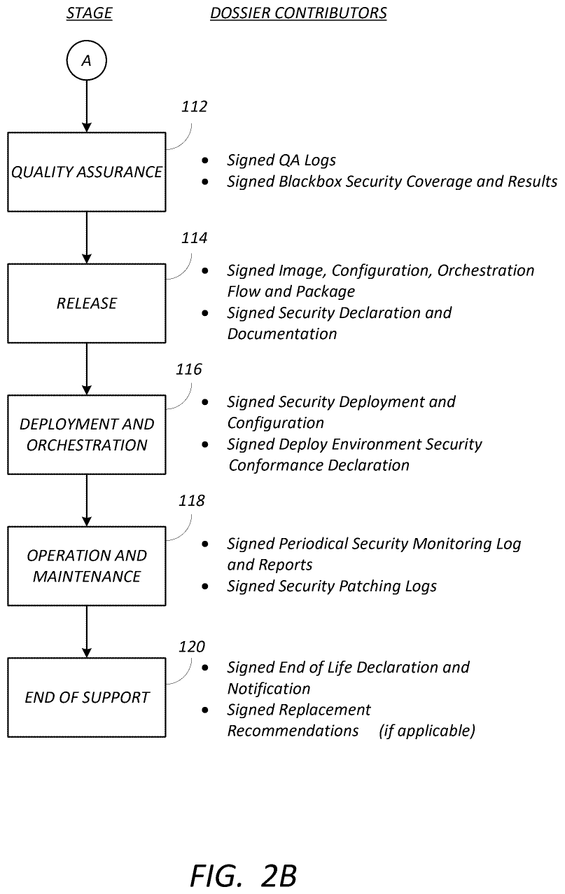

FIGS. 1A and 1B are diagrams presenting illustrations of an overview of software supply chain security related elements by stage of software development. FIGS. 2A and 2B are diagrams presenting illustrations of exemplary software dossier contributions for each stage. Referring first to FIG. 1A and FIG. 2A, block 102 refers to a planning and analysis stage 102. In this stage, the product and security are reviewed to plan implementation requirements. From a security standpoint, in this stage, security risks of the project are identified, and security requirements are specified. Contributions to the software dossier may include signed documents regarding the planning and analysis of the software and evidences.

Block 104 refers to the design stage. In this stage, the software structure is designed, for example, the functional allocation between software elements is determined, as well as interfaces with hardware and other software. From a security standpoint, in this stage, the security tool and methodology for using these tools to assure security as well as detailed security handlers are identified. Contributions to the software dossier in this stage may include signed design documents and evidences.

Block 106 refers to the development stage. In this stage, the software elements are coded. From a security standpoint, in this stage, this includes provisions for security-aware coding, identification of trusted third parties, security-covered unit testing, and signed software check-in for all contributors given access to the code. Contributions to the software dossier in this stage may include signed conformance declarations (declarations from the developers indicating that the software coding conforms to requirements), signed security unit testing results, and signed check-in information (indicating individuals who have been involved with the development of the software at this stage).

Block 108 refers to the build stage. The build stage may include the process of converting source code files into standalone software artifact(s) that can be run on a processor. From a security standpoint, in this stage, this includes signature verification of the software codes to be built if required, third party code and library validation, build log integrity and signing, and software image integrity and signing. Contributions to the software dossier at this stage may include signed build logs, signed images, signed configurations, orchestration flow and packaging.

Block 110 refers to the integration and test stage. In this stage, the software is configured as it will be used by customers and clients (e.g., installed on computers and processors), and tested to assure it complies with performance and operational requirements. From a security standpoint, this stage includes image validation, full coverage for known threats from a software end-to-end perspective. Contributions to the software dossier at this stage may include signed integration logs, and signed security coverages and results.

Referring to FIG. 1B and FIG. 2B, block 112 illustrates the quality assurance stage. At this stage, the completed software is evaluated for quality assurance. Quality assurance is a set of activities that ensure processes, procedures as well as standards are suitable for the project and implemented correctly. Although implemented serially with other stages, quality assurance is a process that works in parallel with other stages, and focuses on improving the process of development of software so that problems can be prevented before they become major issues. From a security standpoint, in this stage, this includes image validation, full coverage of known black box threat scanning, and a quality assurance log that is signed to ensure integrity. Contributions to the software dossier at this stage may include signed QA logs, and signed black box security coverage and results.

Block 114 refers to the release state. In this stage, the software is deemed ready, but further tasks must be performed before releasing it to consumers. The necessary documentation is prepared, including user manuals, installation guides, and release notes. The software is packaged if applicable, and prepared for distribution. From a security standpoint, this stage includes image, configuration, orchestration flow and package signing, security declarations and documentation, and attestable evidences. Contributions to the software dossier in this stage may include signed software images, signed software configurations, orchestration flows, and software packages, as well as signed security declarations and supporting documentation.

Block 116 refers to deployment and orchestration. In this stage, the software is deployed to the production environment or made available for download. This involves installing and configuring the software on target systems or uploading it to an application store or website for users to access. Deploying the software to different platforms and environments while ensuring proper configuration and compatibility can be complex. Handling different operating systems, hardware variations, and network environments requires careful planning, testing, and documentation. From a security standpoint, in this stage, this includes image/package validation, configuration validation, orchestration flow validation, and assessments of the security of the deployment environment. Contributions to the software dossier in this stage may include signed security deployment and configuration documentation, and signed declarations of deployment environment security conformance.

Block 118 refers to operation and maintenance. In this state, the deployed software is operated by customers and maintenance is performed. For example, the software bugs or vulnerabilities may be discovered that require patching or other changes, and the software may need to be modified to be compatible with new processor regimes. From a security standpoint, this stage includes provision for a secure operational environment, secure operations, security monitoring and reporting, and provision and installation of security patches when appropriate. Contributions to the software dossier in this stage may include signed periodical monitoring logs and reports and signed security patching logs.

Block 120 refers to end of support. In this stage, the software is no longer supported. From a security standpoint, this stage may include an end-of-life declaration and notification to end users, and replacement recommendations. Contributions to the software dossier at this point may include a signed version of the end of life declaration and notification and signed replacement recommendations.

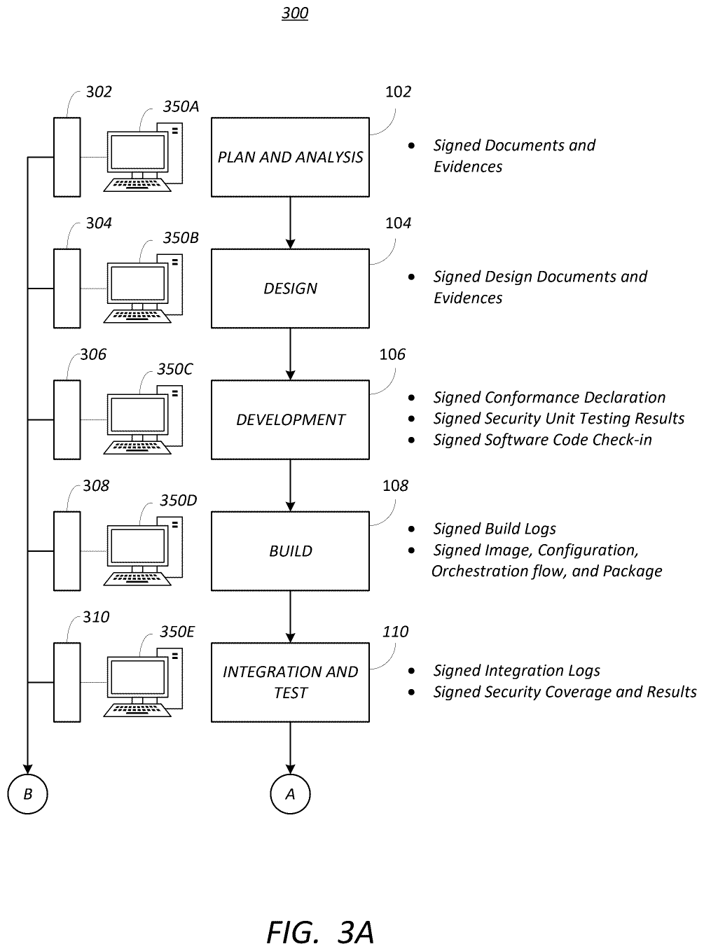

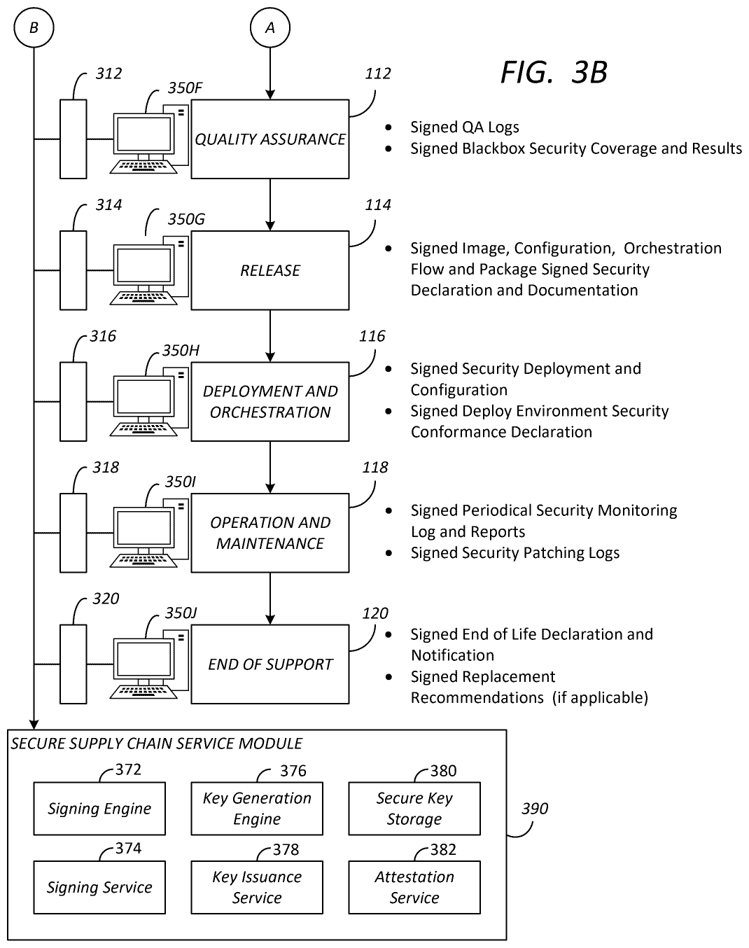

FIGS. 3A and 3B are diagrams illustrating an overview of the software management system (SMS) 300. The SMS 300 comprises a secure supply chain service module (SCSM) 390 communicatively coupled processing stations 350A-350J via one or more interfaces 302-320 (which may comprise any combination of application program interfaces (APIs) and/or software plugins). This allows the SCSM 350 to interface with the processing stations 350C-350D and the software development tools—e.g., Integrated Development Environments (IDEs) implemented by these platforms, to provide key issuance, signing, validation and attestation functions at any stage of the lifecycle of the software.

Referring to FIG. 3B, the SCSM 390 includes a signing engine 372, a signing service 374, highly secure storage 380 for storing keys used in the signing process, a key generation engine 376, a key issuance service 378, and an attestation service 382. Software source codes, binary executables, scripts, configurations, security scanning logs, building and testing logs, operation logs, software planning and designing documents can be signed locally by platforms 350A-350J or by the signing engine 372 and signing service 374 of the SCSM 350, and the keys used to sign these documents can be generated by the key generation engine 376 and stored in secure key storage 380 or those obtained from other sources.

The attestation service 382 permits the attestation of any signed software source codes, binary executables, scripts, configurations, security scanning logs, building, and testing logs, operation logs, software planning and designing documents to software user as third party attestation of all these security compliance evidences.

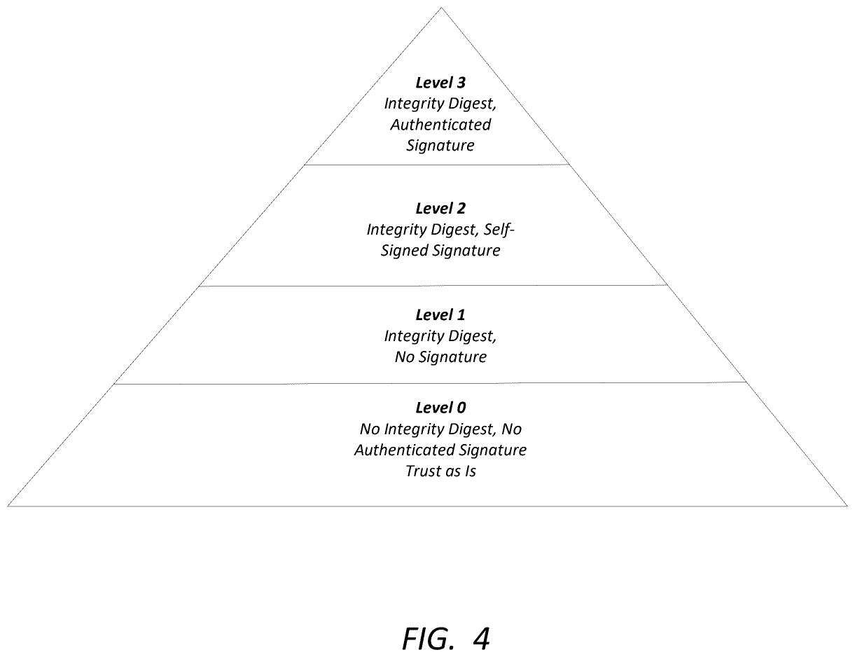

FIG. 4 is a diagram presenting summary of different levels of software trustworthiness. Depending on the application of the software, any of the four levels of software trustworthiness may be acceptable. Unmanaged and untrusted software is at the bottom level (Level 0). This is essentially “as is” software that has no level of security associated with it. As such, it does not include a digest or hash to assure its integrity (e.g., that it has not been modified), and is not signed. The next level (Level 1) is software whose integrity is provided, but not necessarily trustable. (e.g., it has a digest or hash that can be used to verify that the software has not been modified, but is not signed.

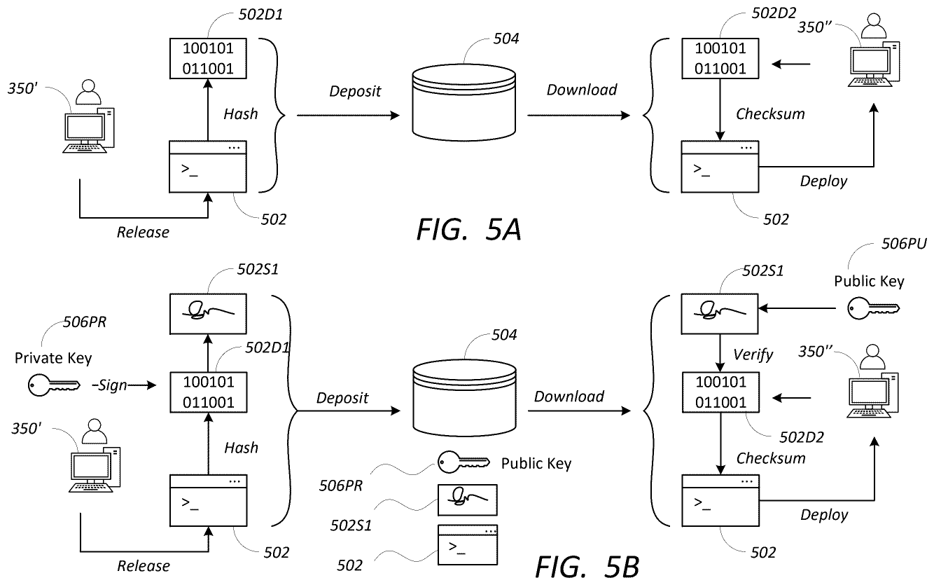

FIG. 5A is a diagram illustrating the dissemination of software with Level 1 trustworthiness. The first user's platform 350′ creates the software, and a hash of the software is computed. The software 502 and hash 502D1 are delivered to storage 504, where they can be accessed by another entity or user's platform 350″. That user uses the platform 350″ to re-compute a hash 502D2 of the software 502, and compare the resulting recomputed hash 502D2 to the hash 502D1 obtained from storage 504. If hashes 502D1 and 502D2 match, the software 502 is deemed to have not been tampered with. For a quicker but less secure determination, the checksum of hash 502D1 can be compared to a checksum of hash 502D2.

FIG. 5B is a diagram illustrating the dissemination of software of with Level 2 trustworthiness. Level 2 trustworthiness refers to software with trusted integrity (e.g., verified by a digest that is signed), but the signature is not authenticated and is hence not fully trustworthy. As shown, user platform 350′ is used to generate a hash 502D1 of the software 502, and that hash 502D1 is signed using private key 506Pr of a crypto key pair to generate a signature 502S1. The private key 506Pr and public key 506Pu are typically generated by the user's platform 350, but may be obtained from a third party. The software 502 and signed hash 502S1 is deposited in the storage 504 where it can be accessed by another entity or user's platform 350″. The platform 350″ of the other user is used to decrypt the signed hash 502S1, using public key 506Pu. The public key 506Pu may have been retrieved from storage 504 or obtained elsewhere. A hash 502D2 of the software 502 is regenerated and compared to the decrypted hash. If the hashes match, the software 502 is deemed to have been not tampered with and authenticated as to source. However, this process is a self-signing process (as the first platform 350′ is used to sign the hash using the first platform's private key 506PR.

The top level (Level 4) of software trust includes software whose integrity is trusted (e.g., verified by a digest), and is signed by an authenticated signature from a trustable source.

### Signing and Provisioning of Designated Information

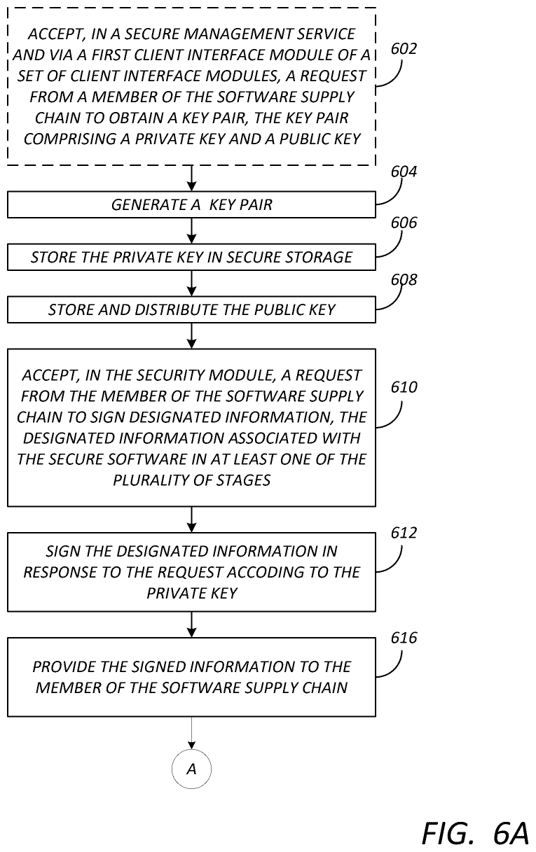

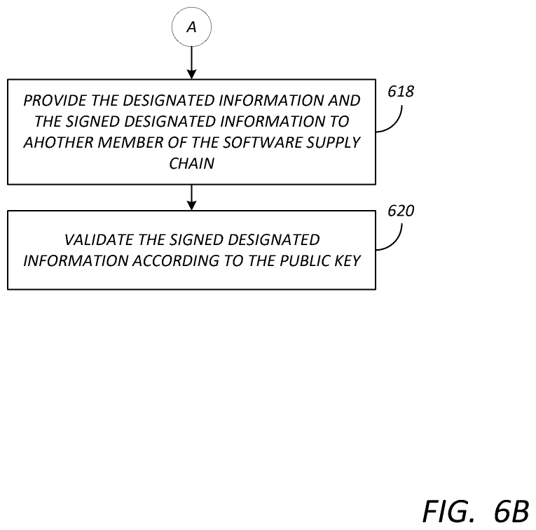

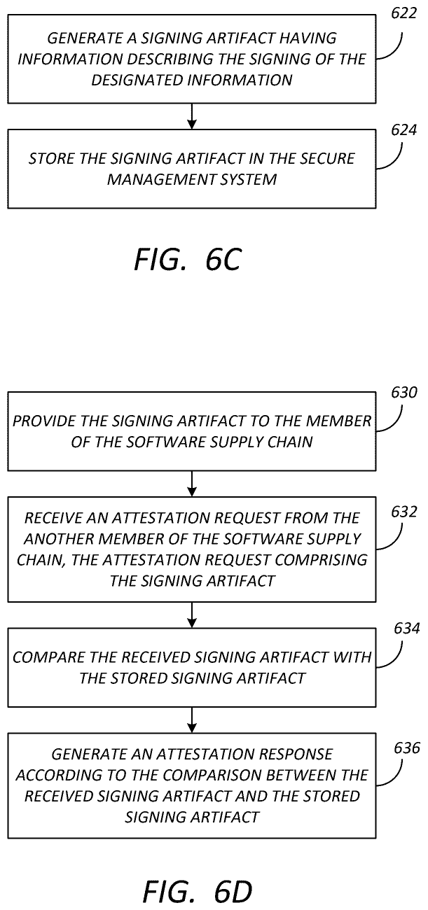

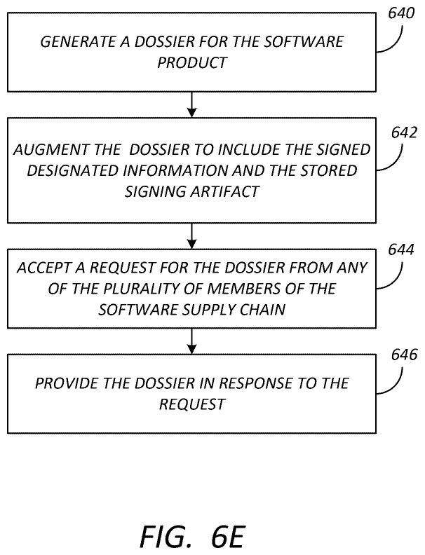

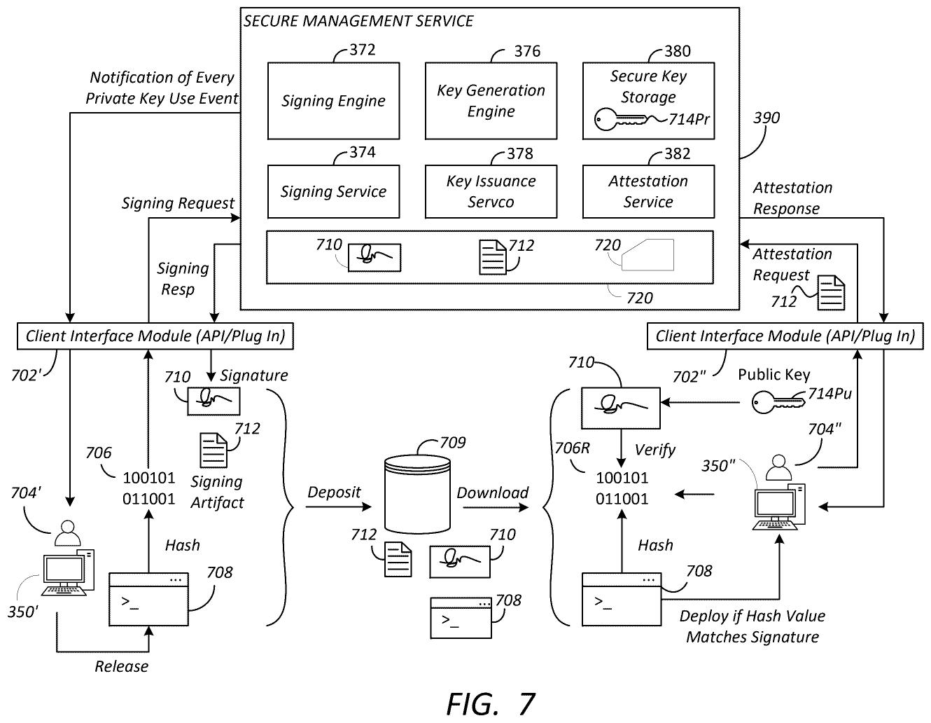

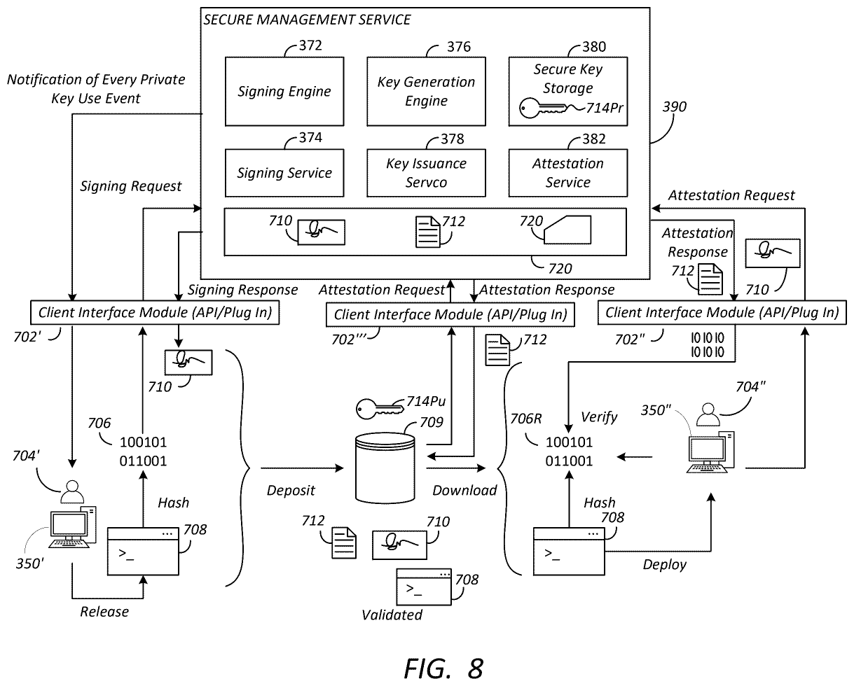

FIGS. 6A-6E are a diagrams illustrating exemplary operations of the SCSM 390. FIGS. 6A-6e will be discussed in conjunction with FIGS. 7 and 8.

Turning to FIG. 6A, a key pair having a private key 714Pr and a public key 714Pu is generated using the key generation engine 376, as shown in block 604. As determined by the key issuance service 378, the key pair can be generated on demand (e.g. in response to the key pair generation request illustrated in block 602, or in response to a demand to sign designated information and no key has been generated or assigned to the requesting member of the software supply chain), or key pairs may be generated in advance and allocated upon demand. The member 704′ of the software supply chain may specify a key length and the algorithm used to generate the key pair, or this may be imposed by the SCSM 390 based upon security requirements. Further, different key pairs may be generated for a particular member 704. For example, a software build may require a stronger key pair than log-in information.

The private key 714Pr is stored in secure key storage 380, as shown in block 606. The secure key storage 380 may include provision for storing keys at different levels of security, reserving the highest security for those private keys requiring such levels of security. The public key 714Pu is also stored as shown in block 608. Since it is eventually made public, the public key 714Pu may be stored in storage less secure than secure key storage 380.

Turning to FIG. 7, the member 704′ of the software supply chain generates information 706. The information 706 may be any information relevant to or derived from the planning, designing, developing, deploying or operation of the software, including the information described in FIGS. 2A-3B.

In the embodiment illustrated in FIG. 7, the information 706 is depicted as a cryptographic hash of a software release 708. The hash is signed rather than the software release itself because software releases are typically too large to be efficiently signed. The member 704′ of the software supply chain then generates a signing request and provides the information 706 to the SCSM 390 via a client interface module 702′, which can be, for example, an application program interface (API) or plug in. In other embodiments, software executing on the processing station 350′ being used by member 704′ automatically generates signing requests based on the information generated by the member 704′. For example, such software may be configured to automatically generate a request to sign log-in information whenever the member 704′ logs into the system. The software may also generate a signing request for a software build when certain milestones have been achieved, or on a periodic basis. Such information may be particularly valuable when determining, for example, when a particular change has been made to the software build.

A message is transmitted from the member 704A of the software supply chain via client interface 702′ is received and accepted by the SCSM 390, as shown in block 610. Each processing station being used by a member 704 of the supply chain may have its own client interface module 702′, 702″. In one embodiment, the client interface modules 704 comprises an application programming interface (API) or plug in executing on the processing station associated with the member 704.

The message comprises a request is to sign designated information associated with the secure software at one or more of the plurality of stages. The designated information may include, for example, any combination of items or singular item listed in FIGS. 2A-2B.

In block 612, the signing service 374 of the SCSM 390 retrieves the private key from secure key storage 380, AND the signing engine 372 of the SCSM 390 signs the designated data in response to the request, according to the private key generated in block 604.

In block 616, the SCSM 390 provides the signed information to the member 704′ of the software supply chain.

Turning to FIG. 6B, the designated information 706 and the signed designated information 710 is provided to another member 704″ of the software supply chain. That another member 704″ validates or verifies the signed designated information according to the public key 714Pu, as shown in block 620.

In the embodiment illustrated in FIG. 7, the designated information (as illustrated, a hash of the software release) and the signed designated information are provided to the another member 704″ via a software repository server 709. However, the same data may be provided by direct messaging or other means.

To validate the signed designated information, the another member 704″ uses the public key 714Pu to verify the signature. This is accomplished by using the public key 714Pu to decrypt the signature, thus regenerating the designated information (hash). The another member 704″ also generates its own version of the designated information by generating a hash 706R of the software and compares that version of the designated information to the regenerated designated information 706R. If he regenerated designated information 706R matches the decrypted designated information 706, the software 708 is deemed to have been untampered with. In one embodiment, the comparison of the designated information and the regenerated designated information is accomplished via a checksum.

The public key 714Pu can be provided to the another member 704″ directly from member 704′, or may be provided by the SCSM 390. Further, if the public key 714Pu is provided by the SCSM 390, that public key 714Pu may be pushed by the SCSM 390 or pulled by the processing station 350″ associated by the another member 704″.

The aforementioned comparison may alternatively be performed by the SCSM 390. In this embodiment, the another member 704″ provides the signed designated information to the SCSM 390 (e.g., via client interface module 702″), and the SCSM 390 uses the public key 714Pu to attempt to authenticate the designated information, and provides the result to member 704″.

In one embodiment, the SCSM 390 logs each use of the private key 714Pr and notifies the owner of that private key (e.g., member 704′) that the private key 714Pr has been used. Such notification can be made upon the use of the private key 714Pr, after a signing request has been made but before the signing of the designated information occurs (giving member 704′ or a supervisor of the member 704′ the opportunity to disallow such use), or after the designated information 706 has been signed and provided for use. Notification can also be accomplished on a periodic basis, with a log of all uses of the private key 714Pr over a that period.

### Signing Artifacts

FIG. 6C is a diagram illustrating exemplary operations used to generate and store signing artifacts. In block 622, the signing artifact 712 is generated. A signing artifact 712 comprises information describing the signing of the designated information 706 including metadata regarding the signature 710 (e.g. which member 704′ sourced the requested the signing of the designated information 706; one or more time stamps describing when the signature 710 was requested, performed, or transmitted; an identifier of the processing station 350′ used by the member 704′; an identifier of the entity signing the designated information 706; and the period over which the signature 710 is valid). In block 624, the signing artifact is stored in the SCSM 390.

Artifacts 712 can be provided to other members 704″ of the software supply chain. FIG. 6D is a diagram illustrating exemplary operations used to share signing artifacts with other members 704 and to use them in attestation processes.

In block 630, the signing artifact 712 is provided to the member 704′ of the software supply chain that requested signing the designated information 706. This is illustrated in FIG. 7, wherein a signing artifact 712 produced from the signing of the designated information 706 (along with the designated information 712 (e.g., the software hash), and signature 710) is provided to other member 704″. This can be accomplished by providing the signing artifact 712 directly from the SCSM 390 to member 704″ (pushed by SCSM 390 or pulled by member 704″), or by providing the signing artifact 712 to the member 704′ that requested the signature, and permitting that member 704′ to provide the artifact to member 704″, for example, via the software repository server 709.

If the artifact is provided from the SCSM 390, the other member 704″ can be assured of the authenticity of the artifact 712. The SCSM 390 may also sign the artifact 712 using a private key, and provide the signed artifact 712 to the other member 704″ along with the public key so that the other member 704″ may validate the artifact 712.

### Attestation

The SCSM 390 includes an attestation service 382 which can be used to perform attestation of signing artifacts 712, signatures 710, or other data. Attestation can be used to allow a member 704 to verify data or to prove to a remote party that the software executing on a processing station 350 of one of the members 704 that its operating system and application software are intact and trustworthy. Attestation can also be used to verify signing artifacts and dossiers, as described further below.

A basic attestation protocol is described as follows. First, a software program “A” running on the processing station 305′ used by member 704′ generates a public/private key pair PK_{A} & SK_{A} and asks the SCSM 390 to certify it. Next, the SCSM 390 computes a hash value #A of the executable code of software program “A”. The SCSM 390 creates a certification including PK_{A} and #A and signs it with a secret attestation identity key SK_{AIK}. When application “A” wishes to authenticate itself to a remote party such as another member 704″, it sends the certification of its public key and hash value #A along with data showing that the SCSM 390 is trusted (for example, a certificate issued to the SCSM 390 by a trusted certification authority (CA)). The remote party verifies the certification chain, then attempts to map #A to a locally generated hash of application A. If the hashes match, application “A” is attested to and is deemed trustworthy.

The attestation request may be received from any member 704 of the software supply chain, and the attestation response can be provided to any member 704. For example, member 704′ may wish to provide attested data to another member 704″. The attestation request may be received from member 704′ with the attestation response delivered to member 704′ and forwarded to member 704″, or the attestation response may be provided directly to member 704″. Furthermore, the first member 704′ or second member 704″ may provide information to the SCSM 390 for attestation.

The information being attested to may include signing artifacts 712. For example, If the artifact 712 is provided via member 704′, the member 704″ receiving the artifact 712 may then provide the signing artifact 712 to the SCSM 390 in an attestation request, as shown in block 632. The SCSM 390 can then compare the received signing artifact 712 with the artifacts in the dossier 720 stored for this particular software asset, as shown in block 634, and determine whether the artifacts 712 match. Finally, as shown in block 636, an attestation response is generated according to the comparison and provided to member 704″. If the artifacts 712 match, the attestation response indicates that the artifact 712 obtained from member 704′ is genuine and that the signing details are correct. If the artifact is obtained by member 704″ from the SCSM 390, attestation may not be required.

In another embodiment, the comparison of signing artifacts is performed by other member 704″ instead of the SCSM 390. In this instance, the SCSM 390 receives an attestation request from the other member 704″ and transmits the signing artifact 712 to the other member 704″. The other member then compares the signing artifact received from member 704′ with the signing artifact received from the SCSM 390 to determine whether they match.

### The Dossier

In one embodiment, the SCSM 390 generates and maintains a dossier 720. The dossier 720 is a record that is augmented each time the SCSM 390 is requested to perform a software-related service for a member 704 of the software supply chain, including signing or attesting to information. The dossier 720 includes, for example, signing artifacts 712, and may include signed data 710 as well.

The dossier 720 can be provided upon request to any of the plurality of the members 704 of the software supply chain (or other authorized entities such as an auditor) to authenticate or verify the actions recorded therein. The dossier 720 provides forensic information that can be used to reconstruct events related to the planning, designing, developing, deploying, and operation of the software product by the software supply chain. As further described below, the dossier and/or the artifacts therein may be signed by the SCSM 390 to allow authentication, and may be the subject of an attestation request. The SCSM 390 may sign the dossier 720 on behalf of one of the members 704 of the software supply chain, or on behalf of itself (e.g., using the stored private key 714Pr of the member 704 or using a private key of the SCSM 390).

FIG. 6E is a diagram illustrating one embodiment of a process for providing the dossier. In block 640, the SCSM 390 generates a dossier 720 for the software product. In block 642, the SCSM 390 augments the dossier 720 to include the signing artifact 712. In block 644, the secure management service 390 accepts a request for the dossier 720. In block 646, the dossier is provided to the requesting entity. The dossier 720 may be signed according to a private key of the SCSM 390, with the dossier 720 and the signed version of the dossier 720 provided to the entity along with the public key of the SCSM 390.

FIG. 8 is a diagram illustrating another embodiment of process steps for performing verification and attestation. As described above, verification and attestation of signed designated information 706, artifacts 712, and other information may be performed by any member 704 of the software supply chain. In addition, verification and attestation may be performed by the software repository server 709. Signatures can be verified locally (e.g., by the member 704′ receiving the signature) or remotely (for example, by the SCSM 390 if the receiving member 704″ does not have the public key. In addition to verification, attestation of related signing artifacts may provide additional validation. Such signing artifacts may be securely stored in the SCSM 390 for purposes of performing such attestation. Further, artifacts may be signed by the attestation service 382.

In this embodiment, verification and attestation are performed by the software repository server 709. The first member 704′ generates a hash 706 of the software 708 and provides the hash (designated information) to the SCSM 390 in a signing request. The SCSM 390 accepts the request in the signing service 374, retrieves the private key 714Pr from secure key storage 380, and uses the signing engine 372 to sign the hash 706. The signed hash 710 is returned to the first member 704′, who deposits the software 708, hash 706, signed hash 710, and a signing artifact 712 in the software repository server 709. The software repository server 709 then verifies software using the public key 714Pu (which can be obtained from member 704′ or the SCSM 390 via client interface module 702″ “′. The software repository server 709 can also send an attestation request to the secure management service 390. In one embodiment, the attestation request comprises the signing artifact 712 and the SCSM 390 compares the provided signing artifact 712 with the signing artifact 712 stored by the SCSM 390, and transmits the attestation response (confirming or denying that the signing artifact 712 provided by the member 704 matches the signing artifact 712 generated and stored when the hash of the software was signed). In another embodiment, the attestation request comprises information that the SCSM 390 uses to identify the signing artifact 712 associated with the generated and stored hash, and the SCSM 390 transmits this signing artifact 712 to the software repository server 708. The software repository server 709 may then compare the signing artifact 712 received from the SCSM 390 with the signing artifact received from member 704′.

Member 704” can then download the software 708 along with the signature 710 and attestation 712. The software 708 has already been validated by the software repository server 709, but member 704 can provide an attestation request to the SCSM 390 to further verify the authenticity of the software 708. In the illustrated embodiment, the attestation request comprises the signature 710. The SCSM 390 receives the signature 710, verifies the signature 710, and if the signature is verified, sends an attestation response to member 704″. The attestation response may include the signing artifact 712, the hash 706, or both. The attestation response may also be signed by the SCSM 390 using the private key of the SCSM 390. The member 704 can verify the attestation response by comparing the signing artifact 712 or hash 706 received from the software repository server 709 with the signing artifact or hash 706 received from the SCSM 390, respectively.

### Hardware Environment

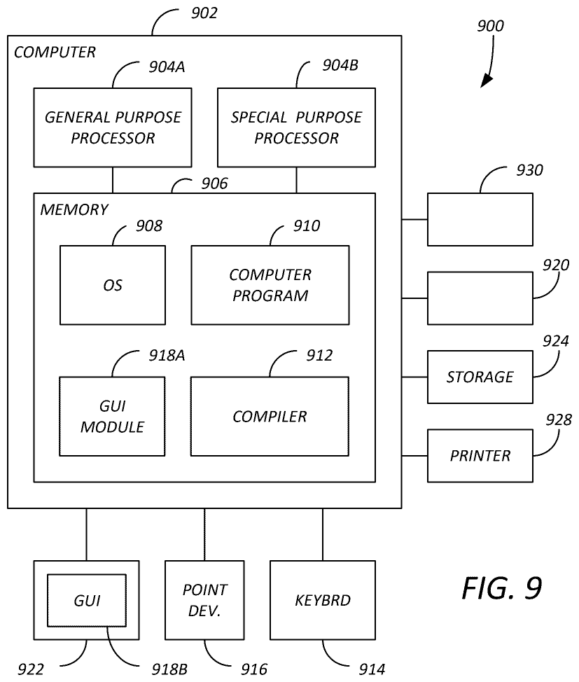

FIG. 9 illustrates an exemplary computer system 800 that could be used to implement processing elements of the above disclosure, including the any of the processors computing the processing threads. The computer 902 comprises a processor 904 and a memory, such as random access memory (RAM) 906. The computer 902 is operatively coupled to a display 922, which presents images such as windows to the user on a graphical user interface 918B. The computer 902 may be coupled to other devices, such as a keyboard 914, a mouse device 916, a printer 928, etc. Of course, those skilled in the art will recognize that any combination of the above components, or any number of different components, peripherals, and other devices, may be used with the computer 902.

Generally, the computer 902 operates under control of an operating system 908 stored in the memory 906, and interfaces with the user to accept inputs and commands and to present results through a graphical user interface (GUI) module 918A. Although the GUI module 918B is depicted as a separate module, the instructions performing the GUI functions can be resident or distributed in the operating system 908, the computer program 910, or implemented with special purpose memory and processors. The computer 902 also implements a compiler 912 which allows an application program 910 written in a programming language such as COBOL, C++, FORTRAN, or other language to be translated into processor 904 readable code. After completion, the application 910 accesses and manipulates data stored in the memory 906 of the computer 902 using the relationships and logic that was generated using the compiler 912. The computer 902 also optionally comprises an external communication device such as a modem, satellite link, Ethernet card, or other device for communicating with other computers.

In one embodiment, instructions implementing the operating system 908, the computer program 910, and the compiler 912 are tangibly embodied in a computer-readable medium, e.g., data storage device 920, which could include one or more fixed or removable data storage devices, such as a zip drive, floppy disc drive 924, hard drive, CD-ROM drive, tape drive, etc. Further, the operating system 908 and the computer program 910 are comprised of instructions which, when read and executed by the computer 902, causes the computer 902 to perform the operations herein described. Computer program 910 and/or operating instructions may also be tangibly embodied in memory 906 and/or data communications devices 930, thereby making a computer program product or article of manufacture. As such, the terms “article of manufacture,” “program storage device” and “computer program product” as used herein are intended to encompass a computer program accessible from any computer readable device or media.

Those skilled in the art will recognize many modifications may be made to this configuration without departing from the scope of the present disclosure. For example, those skilled in the art will recognize that any combination of the above components, or any number of different components, peripherals, and other devices, may be used.

### CONCLUSION

This concludes the description of the preferred embodiments of the present disclosure.

The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

A system and method for traceably planning, designing, developing, deploying, and operating software in a software supply chain is disclosed. In one embodiment, the method comprises accepting, in secure management service via a first client interface module of a set of client interface modules, a request from a member of a plurality of members of the software supply chain to sign designated information, the designated information associated with the secure software in at least one of the plurality of stages, signing the designated information in response to the request according to a private key of a key pair uniquely associated with the member, and providing the signed designated information to the member of the software supply chain.

Implementations may include one or more of the following features.

Any of the above methods, further comprising providing the designated information, the signed designated information, and the public key to another member of the software supply chain, wherein the signed designated information is validated according to the public key.

Any of the above systems, further comprising generating a signing artifact, the signing artifact having information describing the signing of the designated information, and storing the signing artifact in the secure management service.

Any of the above methods, further comprising: providing the signing artifact to the member of the software supply chain, receiving an attestation request from the another member of the software supply chain, the attestation request comprising the signing artifact, comparing the received signing artifact with the stored signing artifact, and generating an attestation response according to the comparison between the received signing artifact and the stored signing artifact.

Any of the above systems, further comprising receiving an attestation request from the another member of the software supply chain and providing the stored signing artifact to the another member of the software supply chain for comparison with the received signing artifact.

Any of the above methods, further comprising augmenting a dossier to include the signed designated information and the stored signing artifact, the dossier provided, upon request, to any of the plurality of members of the software supply chain.

Any of the above systems, further comprising accepting, in a secure management service, a request for the dossier from any of the plurality of members of the software supply chain and providing the dossier in response to the request.

Any of the above methods, wherein: the secure management service comprises a second key pair, the second key pair comprising a second private key and a second public key, and the dossier is signed by the secure management service according to the second private key.

Any of the above systems, wherein: the designated information and the signed designated information is provided to the second member of the software supply chain via a software repository server.

Any of the above methods, wherein: the public key is provided by the member of the software supply chain to the second member of the software supply chain.

Any of the above systems, wherein: the public key is provided to the another member by the secure management service on behalf of the member of the software supply chain.

Any of the above methods, wherein: the signed, designated information is validated by: accepting, in the secure management service via another one of the set of client interface modules, a request from the another member of the software supply chain to validate the signed designated information using the public key; validating, in the secure management service, the signed designated information using the public key; and providing the validation to the another member of the software supply chain.

Any of the above systems, wherein: the signed, designated information is validated by: accepting the public key from the member of the software supply chain or the secure management service; and validating the signed designated information using the public key.

Any of the above methods, wherein: the designated information includes member login data; security requirements; a software build log; a software image; a quality assurance log; a security declaration and security documentation; security monitoring information; a security patch; an integration log; a software end of life declaration; and a software replacement recommendation.

Any of the above systems, wherein: the secure management service generates a reminder for the member of a plurality of members of the software supply chain to sign the designated information.

Any of the above systems, further comprising generating the key pair uniquely associated with the member; storing the private key in secure storage; and storing the public key.

Any of the above systems, wherein: the secure storage stores the private key at a plurality of selectable security levels.

Any of the above systems, wherein: the secure management notifies the member of the software supply chain each time the secure management service uses the private key.

Another embodiment is evidenced by a system for traceably planning, designing, developing, deploying, and operating software. The system comprises: a processor and a memory communicatively coupled to the processor. The memory comprises processor instructions including processor instructions for: accepting, in secure management service via a first client interface module of a set of client interface modules, a request from a member of a plurality of members of a software supply chain to sign designated information, the designated information associated with the secure software in at least one of the plurality of stages; signing the designated information in response to the request according to a private key of a key pair uniquely associated with the member; and providing the signed designated information to the member of the software supply chain.

Still another embodiment is evidenced by a system for traceably planning, designing, developing, deploying, and operating software. The system comprises: means for accepting, in secure management service via a first client interface module of a set of client interface modules, a request from a member of a plurality of members of a software supply chain to sign designated information, the designated information associated with the secure software in at least one of the plurality of stages; means for signing the designated information in response to the request according to a private key of a key pair uniquely associated with the member; and means for providing the signed designated information to the member of the software supply chain.

What is claimed is:

1. In a software supply chain having a plurality of stages of a software life cycle, a method of traceably planning, designing, developing, deploying, and operating software, comprising:
accepting, in secure management service via a first client interface module of a set of client interface modules, a request from a member of a plurality of members of the software supply chain to sign designated information, the designated information associated with the secure software in at least one of the plurality of stages;
signing the designated information in response to the request according to a private key of a key pair uniquely associated with the member; and
providing the signed designated information to the member of the software supply chain.

2. The method of claim 1, further comprising:
providing the designated information, the signed designated information, and the public key to another member of the software supply chain; and
wherein the signed designated information is validated according to the public key.

3. The method of claim 2, further comprising:
generating a signing artifact, the signing artifact having information describing the signing of the designated information; and
storing the signing artifact in the secure management service.

4. The method of claim 3, further comprising:
providing the signing artifact to the member of the software supply chain;
receiving an attestation request from the another member of the software supply chain, the attestation request comprising the signing artifact;
comparing the received signing artifact with the stored signing artifact;
generating an attestation response according to the comparison between the received signing artifact and the stored signing artifact.

5. The method of claim 3, further comprising:
receiving an attestation request from the another member of the software supply chain; and
providing the stored signing artifact to the another member of the software supply chain for comparison with the received signing artifact.

6. The method of claim 3, further comprising:
augmenting a dossier to include the signed designated information and the stored signing artifact, the dossier provided, upon request, to any of the plurality of members of the software supply chain.

7. The method of claim 6, further comprising:
accepting, in a secure management service, a request for the dossier from any of the plurality of members of the software supply chain; and
providing the dossier in response to the request.

8. The method of claim 7, wherein:
the secure management service comprises a second key pair, the second key pair comprising a second private key and a second public key;
the dossier is signed by the secure management service according to the second private key.

9. The method of claim 2, wherein the designated information and the signed designated information is provided to the second member of the software supply chain via a software repository server.

10. The method of claim 2, wherein the public key is provided by the member of the software supply chain to the second member of the software supply chain.

11. The method of claim 2, wherein the public key is provided to the another member by the secure management service on behalf of the member of the software supply chain.

12. The method of claim 2, wherein the signed, designated information is validated by:
accepting, in the secure management service via another one of the set of client interface modules, a request from the another member of the software supply chain to validate the signed designated information using the public key;
validating, in the secure management service, the signed designated information using the public key; and
providing the validation to the another member of the software supply chain.

13. The method of claim 2, wherein the signed, designated information is validated by:
accepting the public key from the member of the software supply chain or the secure management service; and
validating the signed designated information using the public key.

14. The method of claim 1, wherein the designated information includes:
member login data;
security requirements;
a software build log;
a software image;
a quality assurance log;
a security declaration and security documentation;
security monitoring information;
a security patch;
an integration log;
a software end of life declaration; and
a software replacement recommendation.

15. The method of claim 1, wherein the secure management service generates a reminder for the member of a plurality of members of the software supply chain to sign the designated information.

16. The method of claim 1, further comprising:
generating the key pair uniquely associated with the member;
storing the private key in secure storage; and
storing the public key.

17. The method of claim 16, wherein:
the secure storage stores the private key at a plurality of selectable security levels.

18. The method of claim 1, wherein:
the secure management notifies the member of the software supply chain each time the secure management service uses the private key.

19. An apparatus for traceably planning, designing, developing, deploying, and operating software, comprising:
a processor;
a memory, coupled to the processor, the memory comprising processor instructions including processor instructions for:
accepting, in secure management service via a first client interface module of a set of client interface modules, a request from a member of a plurality of members of a software supply chain to sign designated information, the designated information associated with the secure software in at least one of the plurality of stages;
signing the designated information in response to the request according to a private key of a key pair uniquely associated with the member; and
providing the signed designated information to the member of the software supply chain.

20. An apparatus for traceably planning, designing, developing, deploying, and operating software, comprising:
means for accepting, in secure management service via a first client interface module of a set of client interface modules, a request from a member of a plurality of members of a software supply chain to sign designated information, the designated information associated with the secure software in at least one of the plurality of stages;
means for signing the designated information in response to the request according to a private key of a key pair uniquely associated with the member; and
means for providing the signed designated information to the member of the software supply chain.
